(19) United States
(12) Patent Application Publication
(10) Pub. No.: US 2026/0104879 A1
(43) Pub. Date: Apr. 16, 2026

(54) Methods and Systems for Monitoring and Controlling Processes Across Clusters

(71) Applicant: T-Mobile Innovations LLC, Overland Park, KS (US)

(72) Inventors: Justin Lawrence Farmer, Raleigh, NC (US); Ivan Maldonado, Apopka, FL (US); David Lee Anthony Ramirez, Apopka, FL (US)

(21) Appl. No.: 18/914,052

(22) Filed: Oct. 11, 2024

(51) Int. Cl. G06F 8/65

(52) U.S. Cl. CPC G06F 8/65

(57) ABSTRACT

A heartbeat database stores a state of a plurality of clusters and a last time of receiving a heartbeat message from each of the clusters. A data store stores a cluster priority list associated with the application process, the cluster priority list comprises a list of the clusters in an order of priority. A process monitoring application of a cluster configured to remain in the ready state when a higher priority cluster is in the active state, update to the active state when the cluster is a highest priority cluster as indicated in the cluster priority list, remain in the active state when the cluster is a highest priority cluster as indicated in the cluster priority list, or remain in the active state when the cluster is a highest priority cluster as indicated in the cluster priority list.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Organizations that experience rapid user growth and increased demand for services may initially manage applications on a few servers. However, as traffic surges, these applications may face frequent downtimes, slow response times, and difficulty deploying updates without disrupting services using the limited number of servers. To address these challenges, organizations have frequently been adopting the use of application orchestration systems, to automate the deployment and scaling of their applications. Application orchestration systems may use a distributed software framework to manage applications across multiple computing environments, to provide enhanced performance and reliability.

### SUMMARY

In an embodiment, a method implemented in an application orchestration system to monitor and control processes across a plurality of clusters in the application orchestration system is disclosed. The method comprises updating, by a first process monitoring application executed by a first server in a first cluster, a state of the first cluster, in which the state indicates that the first cluster is in at least one of a ready state or an active state. In the ready state, the first cluster is operating on standby and not performing an application process, and in the active state, a first main processing application running in the first cluster is actively performing the application process. The method further comprises determining, by the first process monitoring application, that the application orchestration system includes a second cluster in the ready state with a higher priority than the first cluster based on a cluster priority list associated with the application process, and instructing, by the first process monitoring application, the first main processing application in the first cluster to stop performing the application process when the first cluster is in the active state and the application orchestration system includes the second cluster in the ready state with the higher priority than the first cluster. The method further comprises updating, by the first process monitoring application, the state of the first cluster to be in the ready state, and after a predefined period of time, updating, by a second process monitoring application executed by a second server in the second cluster, a state of the second cluster to be in the active state when the second cluster is a highest priority cluster that is in the ready state in the cluster priority list.

In another embodiment, a method implemented in an application orchestration system to monitor and control processes across a plurality of clusters in the application orchestration system is disclosed. The method comprises maintaining, in a first data store of the application orchestration system, a heartbeat database indicating state of each of the clusters and a last time of receiving a heartbeat message from each of the clusters. The state indicates that a cluster is at least one of a ready state or an active state. In the ready state, the cluster is operating on standby and not performing an application process, and in the active state, the cluster is actively performing the application process. The method further comprises maintaining, in a second data store of the application orchestration system, a cluster priority list associated with the application process, wherein the cluster priority list comprises a list of the clusters in an order of priority. The method further comprises determining, by a first process monitoring application executed by a first server in a first cluster, whether the application orchestration system includes a second cluster in the ready state with a higher priority than the first cluster based on the cluster priority list, instructing, by the first process monitoring application, a first main processing application in the first cluster to stop performing the application process when the first cluster is in the active state and the application orchestration system includes the second cluster in the ready state with the higher priority than the first cluster, and updating, by the first process monitoring application, the state of the first cluster to be in the ready state.

In yet another embodiment, an application orchestration system comprises a memory and a plurality of clusters. The memory comprises a first data store configured to store a heartbeat database indicating a state of a plurality of clusters and a last time of receiving a heartbeat message from each of the clusters, the state of a cluster indicates that the cluster is in at least one of a ready state or an active state. In the ready state, the cluster is operating on standby and not performing an application process, and in the active state, the cluster is actively performing the application process. The memory also comprises a second data store configured to store a cluster priority list associated with the application process, the cluster priority list comprises a list of the clusters in an order of priority. The plurality of clusters is associated with the application process, and each cluster comprises a process monitoring application. The process monitoring application comprises instructions, which when executed by a processor of the cluster, causes the process monitoring application to be configured to, when the cluster is in the ready state, remain in the ready state when a higher priority cluster is in the active state, wherein the higher priority cluster is indicated in the cluster priority list, or update to the active state when the cluster is a highest priority cluster as indicated in the cluster priority list, and when the cluster is in the active state, remain in the active state when the cluster is a highest priority cluster as indicated in the cluster priority list, or remain in the active state when the cluster is a highest priority cluster as indicated in the cluster priority list.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system implementing an application orchestration system according to an embodiment of the disclosure.

FIG. 2 is a diagram illustrating a method of monitoring and controlling processes across clusters in the application orchestration system of FIG. 1 according to various embodiments of the disclosure.

FIG. 3 is a diagram illustrating the updating of a cluster priority list and a heartbeat database in the application orchestration system of FIG. 1 according to various embodiments of the disclosure.

FIG. 4 is a flowchart of a first method of monitoring and controlling processes across clusters in the application orchestration system of FIG. 1 according to various embodiments of the disclosure.

FIG. 5 is a flowchart of a second method of monitoring and controlling processes across clusters in the application orchestration system of FIG. 1.

FIG. 6 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

An application orchestration system is a distributed software framework that automates the deployment, scaling, and management of applications across multiple computing environments. The system coordinates various services, containers, and resources to ensure applications run efficiently and reliably, handling tasks such as load balancing, service discovery, and fault tolerance. Organizations of all sizes, especially those with complex, large-scale, or cloud-based applications, may use these systems to streamline operations, enhance scalability, and improve resilience.

The application orchestration system may include multiple clusters, each cluster including a set of nodes (e.g., physical servers or virtual machines (VMs)) that work together to run containerized applications. For example, each cluster may include a control plane that manages the overall cluster, and multiple worker nodes that run the applications.

Georedundancy is the practice of deploying application processes across multiple locations (e.g., across multiple clusters) to ensure continuous availability and resilience against regional failures. By implementing application processes in georedundant manner across different clusters, organizations can protect their applications from localized disruptions such as natural disasters, power outages, or network failures. This approach ensures that if one region's cluster goes down, another in a different location can seamlessly take over, maintaining service continuity.

In some cases, georedundant implementation of application processes across different clusters may also enable a seamless process failover when an active cluster running an application process fails. Process failover refers to the process of seamlessly and automatically switching execution of an application process to a redundant and ready cluster when a primary cluster fails due to an outage, cyberattack, or other issue. For example, suppose the active cluster running an application process fails, and another cluster is a ready and available backup cluster for the application process. The reliable backup cluster may continue execution of the application process in a seamless manner.

However, many application processes and functions are single-threaded by nature. A single-threaded application process is one that processes tasks sequentially in a single thread of execution, without parallelism or concurrent processing capabilities. For these single-threaded application processes, it is imperative that multiple instances of the same application process not be run across different clusters concurrently. This is because when a single-threaded application process runs across multiple clusters concurrently, synchronizing the states between the different instances of the application process may be challenging, leading to inconsistencies and potential data corruption. Race conditions and conflicts may also be encountered when different instances of the application process try to access or modify shared resources simultaneously.

Therefore, while georedundant failover provisioning of single-threaded application processes is desirable, the actual implementation of failover mechanisms across different clusters may be problematic because the application orchestration system may not be able to programmatically distinguish between single-threaded application processes and non-single-threaded application processes. In addition, the application orchestration system may not be enabled to correct the problem to ensure that only one cluster runs a single-threaded application process at one time. Moreover, the application orchestration system may not maintain sufficient data to select an optimal cluster to run the application process. As such, the georedundant implementation of single-threaded application processes with a failover mechanism across different clusters in the application orchestration may give rise to various technical problems, including system inefficiencies and delays, data corruption, and data inconsistencies.

As an illustrative example, a large-scale event (LSE) detector in an incident monitoring and reporting system may be a single-threaded application process implemented using an application orchestration system. An LSE detector essentially uses a set of rules or criteria to group certain alarms received by the system as part of an LSE, such that the root cause of the grouped alarms in the LSE may be addressed as part of a single incident report or with a single remediation action. As such, the order in which alarms are tagged as part of an LSE and addressed together is imperative for efficiency and accuracy purposes. Otherwise, the operator at the network operations center (NOC) may have to review multiple incident reports out of order, in which the reviews correspond to alarms that have not yet been tagged as part of an LSE, but will shortly be tagged as part of the LSE. Therefore, the LSE detector (e.g., application process) should ideally be implemented with a failover mechanism in a geographically redundant manner to ensure operational efficiency, and the single-threaded nature of the LSE detector should be enforced to ensure that the LSE detector is only being executed by one cluster at a single moment in time. However, as mentioned above, the application orchestration system may not be enabled to properly manage the single-threaded application process of the LSE detector while ensuring failover georedundancy. And thus, the execution of the LSE detector at the application orchestration system may give rise to remediation failures, system redundancies, and reporting inconsistencies in the incident monitoring and reporting system.

The present disclosure addresses the foregoing technical problems by providing a technical solution in the technical field of application management, particularly in the context of an application orchestration system. In an embodiment, the application orchestration system may be enhanced to maintain a heartbeat database and a cluster priority list. The heartbeat database may include a state of each cluster with respect to the running of an application process, and the cluster priority list may indicate an ordered list of clusters for running the application process. Each cluster may include a main processing application for running the application process (when permitted) and a process monitoring application for monitoring and updating the state of the cluster using the heartbeat database and the cluster priority list, as further described herein. Therefore, the embodiments disclosed herein are directed to an automated method of ensuring that a single-threaded application process is being executed by a single, optimal cluster at a single point in time, while also retaining the failover georedundant implementation of the single-threaded application process.

As mentioned above, the application orchestration system may be enhanced to include a heartbeat database (e.g., stored at a heartbeat system within or accessible to the application orchestration system) and the cluster priority list (e.g., stored at data store within or accessible to the application orchestration system). The heartbeat database may maintain records for each of the clusters capable of running a particular application process (e.g., the LSE detector). Each record for a cluster may include an identification of a cluster and data obtained from a most recently received heartbeat message from the cluster. For example, each cluster may be programmed to transmit a heartbeat message to the heartbeat server periodically according to a predefined schedule (e.g., every 3 seconds). The heartbeat message may include an identification of the cluster, a current location (e.g., address) of the cluster, an identification of a node within the cluster sending the heartbeat message, and a state of the cluster with respect to the application process (e.g., ready, active, offline, online, etc.).

A ready state may indicate that the cluster is online and operating on standby, but not currently performing the application process or a task of the application process. An active state may indicate that the cluster (e.g., a main processing application of the cluster) is currently performing the application process or a task of the application process. An online state may indicate that the cluster is operable or capable of performing the application process, while an offline state may indicate that the cluster is unavailable or incapable of performing the application process. The heartbeat system may store the data received in the heartbeat message in the record for the cluster with a time at which the heartbeat message was received (e.g., indicating that the cluster was last reported to be online and in the indicated state at the time the heartbeat message was received). In this way, the heartbeat system maintains a state of each cluster and a last received time of the state of each cluster associated with an application process.

The cluster priority list may include an ordered list of the clusters in the application orchestration system that are capable of performing the application process (e.g., the clusters in the application orchestration system that have been programmed with the application process for georedundancy purposes). Only the clusters that are capable of performing the application process may be included in a cluster priority list for the application process. As an example, the cluster priority list may indicate that a first cluster has a highest priority, a second cluster has the second highest priority, a third cluster has the next highest priority, and so on, until the last cluster with the lowest priority.

As mentioned above, each cluster may run a main processing application and a process monitoring application in parallel (e.g., the tasks performed by the process monitoring application may be considered a sub-process of the processing performed by the main processing application). The main processing application may perform (e.g., run or execute) the application process, while the process monitoring application may perform monitoring and state updates for the cluster. Whether or not the main processing application is running the application process, the process monitoring application may be programmed to perform monitoring and state updates according to a predefined schedule (e.g., every 3, 5, 10, or 30 seconds).

The process monitoring application of each cluster may begin the monitoring and updating tasks at each interval of the predefined schedule. For example, suppose a first cluster is in an active state, in which the main processing application of the first cluster is performing the application process. In this case, the process monitoring application of the first cluster may determine whether the application orchestration system includes a second cluster with a higher priority than the first cluster, as indicated in the cluster priority list. When the application orchestration system includes the second cluster with the higher priority than the first cluster, the process monitoring application may access the heartbeat system to obtain a state of the second cluster (e.g., request a state of the second cluster from the heartbeat database). The process monitoring application may use the data received from the heartbeat system to determine whether the second cluster is in a ready state (e.g., available to run the process) or not ready state (e.g., not ready to run the process, unavailable, offline, etc.).

When the higher priority second cluster is not in the ready state, the process monitoring application of the first cluster may determine that the first cluster is to remain in the active state and continue performing the application process. However, when the higher priority second cluster is in the ready state, the process monitoring application may instruct the main processing application of the first cluster to stop performing the application process, and in some cases, save application state data to a data store in the application orchestration system. The application state data may include a current status and context of the process, including variables, configurations, and intermediate results, enabling the process to resume at the higher priority cluster from where the first cluster left off rather than starting over.

The process monitoring application of the first cluster may then send a heartbeat message to the heartbeat system, in which the heartbeat message identifies the first cluster, identifies a location (e.g., address) of the first cluster, and indicates that the first cluster is now in the ready state (e.g., no longer in the active state). The heartbeat system may update the record for the first cluster to update the state of the first cluster to the ready state and add a time of receiving the heartbeat message to the record. At this stage, the first cluster may no longer be running the application process, and all of the clusters associated with the application process may wait until the next interval of the predefined schedule to perform the monitoring and updating tasks.

At the next interval of the predefined schedule, all of the clusters associated with the application process, including the higher priority second cluster, may perform the same monitoring and updating tasks. For example, at this stage, the second cluster is still in the ready state, and the application process is no longer being performed by the first cluster. The process monitoring application of the second cluster may determine whether the cluster priority list indicates that another cluster has a higher priority than the second cluster for performing the application process. When the cluster priority list indicates that another cluster has a higher priority, the process monitoring application may access the heartbeat system to obtain a state of the other cluster (e.g., request a state of the second cluster) and determine whether the other cluster is in a ready state or in a not ready state. When the other higher priority cluster is in a ready state, the process monitoring application of the second cluster may determine that the second cluster is to remain in the ready state (since a higher priority cluster is available to perform the application process).

On the other hand, when the cluster priority list does not indicate that another cluster has a higher priority or when the other higher priority cluster is not in a ready state, the process monitoring application of the second cluster may determine whether a lower priority cluster, as indicated in the cluster priority list, is in the active state, as indicated in the heartbeat server. For example, the process monitoring application of the second cluster may obtain an identification of the lower priority clusters from the cluster priority list and then obtain the state of each of these clusters from the heartbeat server. In this case, the first cluster is a lower priority cluster identified in the cluster priority list, but the state of the first cluster is in the ready state (i.e., not in the active state). As such, the process monitoring application of the second cluster may instruct the main processing application of the second cluster to begin performing the application process, in some cases, using the application state data stored by the first cluster (e.g., to resume the application process where the first cluster left off, thereby preventing data corruption and inconsistencies). The main processing application of the second cluster may then begin performing the application process, for example, using the application state data.

The process monitoring application of the second cluster may then send a heartbeat message to the heartbeat system, in which the heartbeat message identifies the second cluster, identifies a location (e.g., address) of the second cluster, and indicates that the second cluster is now in the active state (e.g., no longer in the ready state). The heartbeat system may update the record for the second cluster to update the state to the active state and add a time of receiving the heartbeat message to the record.

In another case, when the first cluster is still performing the application process and thus the state of the first cluster is indicated as active in the heartbeat system, the process monitoring application of the second cluster may determine that the second cluster is to remain in the ready state until the first cluster stops performing the application process and updates the state to ready (to prevent the application process from being performed by multiple clusters at the same time). In this way, the clusters are not only programmed to implement failover georedundancies, but also programmed to explicitly prevent multiple instances of the same application process from concurrently running across different clusters.

In an embodiment, the main processing application may be programmed to send periodic calls to the process monitoring application while performing the application process, as a method of periodically reporting successful application execution. In this way, the process monitoring application may expect periodic calls from the main processing application when the main processing application is performing the application process. The process monitoring application may determine that when at least a threshold number of consecutive calls (e.g., two) have not been received from the main processing application, the main processing application may be experiencing an issue or failure (e.g., hung and not executing properly). In this case, the process monitoring application may instruct the cluster to stop performing the application process and update a state of the cluster in the heartbeat system to indicate that the cluster is in the offline state. A next priority cluster may resume performing the application process at the next interval of the predefined schedule.

In another embodiment, the cluster priority list may be manually or automatically updated. For example, when a failure or outage occurs at one cluster (or one cluster goes offline), the cluster priority list may be manually or automatically updated to remove the unavailable cluster from the cluster priority list. The update to the cluster priority list may trigger the process monitoring application across all of the associated clusters to run the monitoring and updating tasks again, to ensure that the application process is executed by the next highest priority cluster when the unavailable cluster affects the execution of the application process. In an embodiment, the ordered list of clusters in the cluster priority list may be manually or programmatically updated in an easy and efficient manner. By enabling updates to the cluster priority list, the system ensures that the current conditions of all of the clusters are considered for application process execution. For example, when a cluster is undergoing maintenance or a new cluster is added, the cluster priority list may be promptly updated to remove a cluster and/or add the new cluster, to ensure that the application process runs on the highest priority, available and ready cluster, while avoiding clusters that are not available.

Therefore, the embodiments disclosed herein use concurrent threads/processes between the main processing application and the process monitoring application, with the heartbeat system and cluster priority list, to provide failover georedundancies and single-thread enforcement to application processes. In this way, the embodiments disclosed herein serve to reduce system failures, data inconstancies/corruptions, and thus increase the efficiencies and bandwidth of the application orchestration system. Moreover, the embodiments disclosed herein ensure that the highest priority cluster (e.g., the optimal cluster in terms of processing capacity, latency, and other processing/networking attributes) is used to perform a particular application process. Therefore, in general, the embodiments disclosed herein also serve to increase system capacity by dynamically monitoring and modifying the running of an application process across different clusters in the system.

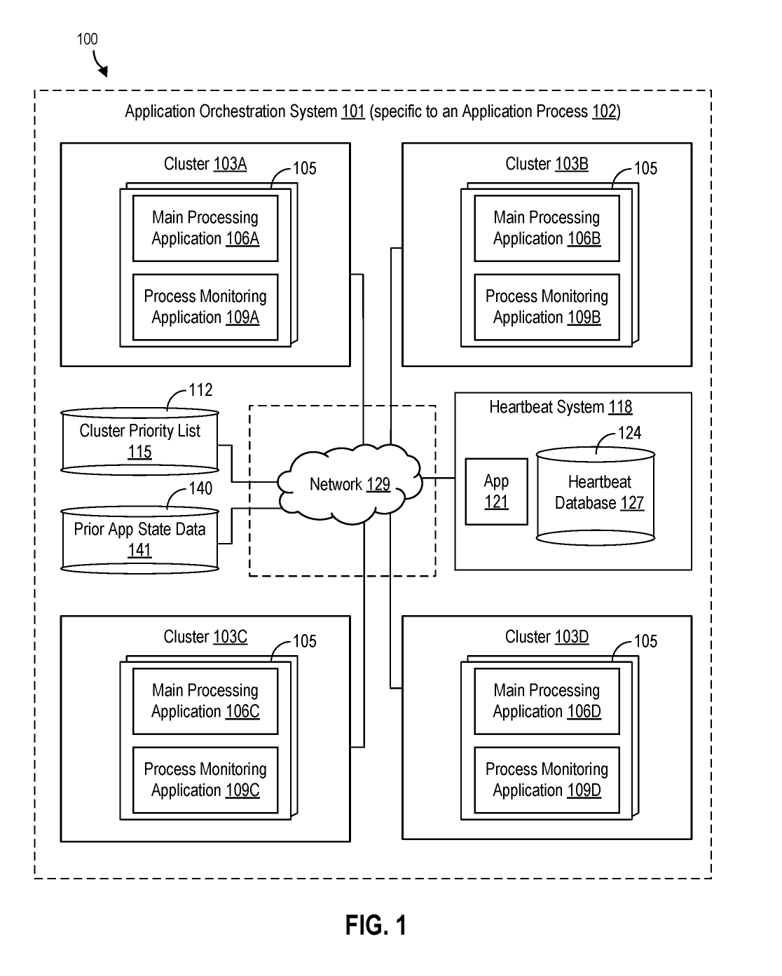

Turning now to FIG. 1, a communication system 100 is described. The communication system 100 includes an application orchestration system 101 and a network 129. The network 129 may be one or more private networks, one or more public networks, or a combination thereof. The dotted lines in FIG. 1 illustrate the virtual boundaries of the application orchestration system 101, which may exclude the network 129. However, while the application orchestration system 101 is shown in FIG. 1 as excluding the network 129, it should be appreciated that in some embodiments, at least some portions of the network 129 may include the different components of the application orchestration system 101.

The application orchestration system 101 shown in FIG. 1 is a portion of the application orchestration system 101 that is specific to a particular single-threaded application process 102. As mentioned above, a single-threaded application process 102 is one that processes tasks sequentially in a single thread of execution, without parallelism or concurrent processing. For example, the single-threaded application process 102 may be an LSE detector, as described above.

The application orchestration system 101 shown in FIG. 1 includes the clusters 103A, 103B, 103C, and 103D associated with the application process 102. The clusters 103A-D may be associated with the application process 102 when the clusters 103A-D are programmed to perform or run the application process 102 within the nodes of the cluster 103A-D. While only four clusters 103A-D are shown as associated with the application process 102 in FIG. 1, it should be appreciated that any number of clusters may be associated with the application process 102.

Each cluster 103A-D may include one or more nodes 105 (e.g., physical servers or virtual machines (VMs)) that work together to run containerized applications, including the application process 102. For example, different clusters 103A-D may be distributed throughout a geographic area and each cluster 103 may be located at, for example, different data centers. Alternatively, different clusters 103A-D may be co-located within a single location (e.g., data center or server), but may each include different nodes 105 (e.g., server or virtual machine) located or provisioned within the single location. Within a single cluster 103A-D, different the nodes 105 may be geographically distributed throughout the nation (e.g., across different data centers or servers). Alternatively, the nodes 105 within a single cluster 103A-D may be co-located together, within for example, a single data center or a single server. In an embodiment, the network 129 may include the different clusters 103A-D, or in particular the different nodes 105 of the different clusters 103A-D.

Each cluster 103A-D includes a main processing application 106A-D and a process monitoring application 109A-D. Cluster 103A includes main processing application 106A and process monitoring application 109A. Cluster 103B includes main processing application 106B and process monitoring application 109B. Cluster 103C includes main processing application 106C and process monitoring application 109C. Cluster 103D includes main processing application 106D and process monitoring application 109D. The main processing application 106A-D may perform (e.g., run or execute) the application process 102 when the respective cluster 103A-D is permitted to perform the application process 102, as described herein. The process monitoring application 109A-D may perform the monitoring and updating tasks described herein to ensure that the highest priority cluster 103A-D (e.g., as indicated in the cluster priority list 115) that is in the ready state (or active state) performs the application process 102, as described herein.

The application orchestration system 101 also includes a data store 112 (e.g., one or more memories) storing the cluster priority list 115 for the application process 102. The cluster priority list 115 may indicate an ordered list of clusters 103A-D for running the application process 102. For example, the cluster priority list 115 may indicate that cluster 103B has the highest priority, cluster 103D has the second highest priority (e.g., lower than cluster 103B), cluster 103A has the third highest priority (e.g., lower than clusters 103B and 103D), and cluster 103C has the lowest priority. In an embodiment, the network 129 may include the data store 112. As further described herein, the cluster priority list 115 may be static and locked, such that another application or individual may not be capable of altering the cluster priority list 115. This is because the ordered list of clusters 103A-D in the cluster priority list 115 may be maintained to ensure accuracy and self-healing whenever a cluster 103A-D is unavailable and then again when the cluster 103A-D is restored. To this end, the updating of the cluster priority list 115, as sometimes referred to herein, may not refer to the altering of the actual cluster priority list 115, but instead may refer to an update to another database storing data associated with clusters 103A-D in the cluster priority list 115 that are alive and capable of performing the application process 102. For example, a copy of the a most recent cluster priority list 115 may be maintained at the data store 112, and this copy may be updated to reflect the removing of unavailable clusters 103A-D and re-addition of restored clusters 103A-D.

The application orchestration system 101 also includes a heartbeat system 118. The heartbeat system 118 includes an application 121 and a data store 124 (e.g., one or more memories) storing the heartbeat database 127. The heartbeat database 127 may maintain records for each of the clusters 103A-D associated with the application process 102. Each record for a cluster 103A-D may include an identification of a cluster 103A-D, a most recently identified location of the cluster 103A-D (e.g., address of one or more nodes/servers/data centers of the cluster 103A-D), a state of the cluster 103 (e.g., active, ready, online, offline, etc.), and a time of the most recently received heartbeat message. For example, each cluster 103A-D (or each node/server/data center) may be programmed to transmit a heartbeat message to the heartbeat system 118 periodically according to a schedule (e.g., every 3 seconds). The heartbeat message may include an identification of the cluster 103A-D, a current location (e.g., address) of the cluster 103A-D (or each node/server/data center) sending the heartbeat message, and a state of the cluster 103A-D with respect to the application process (e.g., ready, active, offline, online, etc.). The application 121 may receive the heartbeat message and update a record in the heartbeat database 127 associated with the cluster 103A-D that sent the heartbeat message. The application 121 may update the record to include the data obtained in the heartbeat message and a time of receiving the heartbeat message (e.g., as a last time of communicating with the cluster 103A-D). In an embodiment, the network 129 may include the heartbeat system 118. The absence of timely received heartbeat messages may be inferred to indicate an offline or failed status.

The application orchestration system 101 also includes a data store 140 (e.g., one or more memories) storing the prior application state data 141 for the application process 102. The prior application state data 141 may include a current status and context of the application process 102 (as stored by a cluster 103A-D after the cluster 103A-D is instructed to stop performing the application process 102). For example, the prior application state data 141 may include variables, configurations, and intermediate results, enabling the application process 102 to resume at the higher priority cluster 103A-D from where another cluster 103A-D left off rather than starting over.

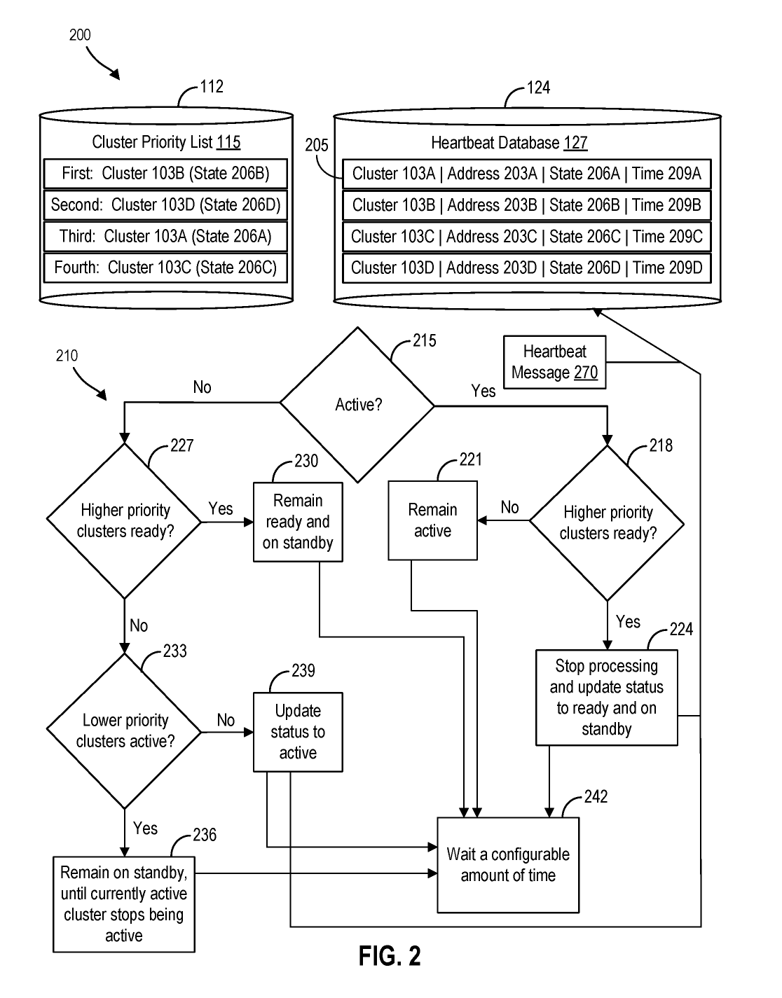

Referring now to FIG. 2, shown is a diagram 200 illustrating the data store 112 storing the cluster priority list 115, the data store 124 storing the heartbeat database 127, and method 210 of monitoring and updating clusters 103A-D. The cluster priority list 115 lists the clusters 103A-D in order of priority, in which a higher priority cluster 103B is deemed an optimal perform an application process 102. The example cluster priority list 115 shown in FIG. 2 is a sequential ordering of clusters 103A-D from high to low priority. However, it should be appreciated that the cluster priority list 115 may indicate a relative priority of each of the different clusters 103A-D for an application process 102 in a variety of different manners (e.g., as a value indicated in a record with a cluster 103A-D, in a list from lowest priority to highest priority, etc.) The cluster priority list 115 may be preset by an operator of the application orchestration system 101 or generated programmatically for example using a machine learning model that has been trained using historical data associated with the running of the application process 102 at the application orchestration system 101.

As shown in FIG. 2, the cluster priority list 115 for the application process 102 is as follows: cluster 103B is the highest priority for running the application process 102, cluster 103D is the second highest priority for running the application process 102 (e.g., lower priority than the cluster 103B), cluster 103A is the third highest priority for running the application process 102 (e.g., lower priority than the clusters 103B and 103D), and cluster 103C is the lowest priority for running the application process 102. According to the cluster priority list 115, the cluster 103B may be considered the most optimal cluster 103B to run the application process 102 based on, for example, available resources and capacity at the cluster 103B, latency occurring at the cluster 103B, requirements of the application process 102, and/or any other resource or network related attribute. The lower priority clusters 103D, 103A, and 103C may be ordered in the order of priority based similarly on the available resources within each cluster 103D, 103, and 103C, latency occurring at each cluster 103D, 103, and 103C, requirements of the application process 102, and/or other any resource or network related attribute.

The cluster priority list 115 may indicate an order of priority using the identities of the clusters 103A-D. For example, the cluster priority list 115 may be a queue or other data structure in which the first data element is the highest priority cluster 103A-D, the second data element is the next highest priority cluster 103A-D, and so on. Each data element in the highest priority cluster 103A-D may also, in some embodiments, include a state 206A-D (e.g., ready, active, offline, online, etc.) of the respective cluster 103A-D. For example, the application 121 may transmit the state 206A-D of each cluster 103A-D to the data store 112 to update the cluster priority list 115 to include the states 209A-D of each cluster 103A-D.

The heartbeat database 127 maintains identification, address (e.g., Internet Protocol (IP) address), state, and time data related to each of the clusters 103A-D associated with the application process 102. As shown in FIG. 2, the heartbeat database 127 comprises a record 205 for each cluster 103A-D associated with the application process 102. Each record 205 may, for example, include an identification of the respective cluster 103A-D, an address 203A-D of the respective cluster 103A-D (e.g., an address of the node(s) 105 hosting the cluster 103A-D/address of the node 105 from which a heartbeat message was received), a state 206A-D of the cluster 103A-D (e.g., ready, active, online, offline, etc.), and a time 209A-D of most recent communications with the cluster 103A-D (e.g., timestamp of receiving the last heartbeat message from the cluster 103A-D).

A ready state may indicate that the cluster is online and operating on standby, but not currently performing the application process or a task of the application process. An active state may indicate that the cluster (e.g., a main processing application of the cluster) is indeed and currently performing the application process or a task of the application process. An online state may indicate that the cluster is operable or capable of performing the application process, while an offline status may indicate that the cluster is unavailable or incapable of performing the application process.

FIG. 2 also illustrates method 210, which may be performed by the process monitoring application 109A-D of each of the clusters 103A-D at predefined time intervals according to a predefined schedule (e.g., every 3, 5, 10, or 30 milliseconds). The process monitoring application 109A-D of each cluster 103A-D may be programmed to perform method 210 at each time interval of the predefined schedule.

Method 210 may begin at operation 215. At operation 215, the process monitoring application 109A-D may determine whether the cluster 103A-D is active or not based on, for example, whether the corresponding main processing application 206A-D is running the application process 102. When the result of the operation 215 indicates that the cluster 103A-D is in the active state, method 210 may move to the right and proceed to operation 218. At operation 218, the process monitoring application 109A-D may determine whether the application orchestration system 101 includes another cluster 103A-D with a higher priority (as indicated in the cluster priority list 115) and if so, whether that higher priority cluster 103A-D is in a ready state (as indicated in the heartbeat database 127). The process monitoring application 109A-D may search the cluster priority list 115 to determine whether there is another cluster 103A-D with a higher priority, and/or request the state 206A-D of an identified higher priority cluster 103A-D from the heartbeat database 127.

In some cases, the cluster priority list 115 automatically updates with the heartbeat database 127, such that each record 205 of the cluster priority list 115 also includes the state 206A-D of the respective cluster 103A-D. In this case, the process monitoring application 109A-D may only need to access the cluster priority list 115 to perform operation 218.

When the process monitoring application 109A-D determines that there is no higher priority cluster 103A-D in the ready state, the process monitoring application 109A-D may determine that the cluster 103A-D is to remain in the active state, as indicated by operation 221. In this case, the process monitoring application 109A-D may determine that main processing application 106A-D of the cluster 103A-D is to continue performing the application process 106.

However, when the process monitoring application 109 identifies another higher priority cluster 103A-D in the ready state, the process monitoring application 109A-D may perform operation 224. At operation 224, the process monitoring application 109A-D may instruct the main processing application 106A-D to stop performing the application process 102. In some cases, the process monitoring application 109A-D may also instruct the main processing application 106A-D to save the prior application state data 141 to a data store 140 accessible by the other clusters 103A-D in the application orchestration system 101. The main processing application 106A-D may then stop performing the application process 102 and store the prior application state data 141 to the data store 140 in the application orchestration system 101.

The process monitoring application 109A-D may then send a heartbeat message 270 to the heartbeat system 118, in which the heartbeat message 270 identifies the cluster 103A-D, identifies an address 203A-D of the cluster 103A-D, and indicates that the cluster 103A-D is now in the ready state (e.g., no longer in the active state). The heartbeat system 118 may update the record 205 for the cluster 103A-D, to update the state 206A-D to the ready state, and add a time of receiving the heartbeat message 270 to the record 205.

For example, suppose the process monitoring application 109A of cluster 103A is performing method 210 when the cluster 103A is in an active state, in which the main processing application 106A of the cluster 103A is performing the application process 102. In this case, the process monitoring application 109A may, at operation 218, determine whether the application orchestration system 101 includes a second cluster 103B with a higher priority than the cluster 103A, as indicated in the cluster priority list 115. When the application orchestration system 101 includes the second cluster 103B with the higher priority than the cluster 103A, the process monitoring application 109A may access the heartbeat system 118 to obtain a state 206B of the second cluster 103B (e.g., request a state 206B of the second cluster 103B) and determine whether the second cluster 103B is in a ready state (e.g., available to run the process) or not ready state (e.g., not ready to run the process, unavailable, offline, etc.). When the higher priority second cluster 103B is not in the ready state, at operation 221, the process monitoring application 109A may determine that the cluster 103A is to remain in the active state and perform the application process 102. However, when the higher priority second cluster 103B is in the ready state, at operation 224, the process monitoring application 109A may instruct the main processing application 106A to stop performing the application process 102 and store prior application state data 141 to the data store 140. At this stage, the cluster 103A may no longer be running the application process 102, and all of the clusters 103A-D associated with the application process 102 may wait until the next interval of the predefined schedule to perform the monitoring and updating tasks.

Referring back to operation 215, when a cluster 103A-D is not in an active state, method 210 may proceed to the left to operation 227. At operation 227, the process monitoring application 109A-D may determine whether the cluster priority list 115 indicates that the application orchestration system 101 includes another cluster 103A-D with a higher priority (as indicated in the cluster priority list 115) and if so, whether that higher priority cluster 103A-D is in a ready state (as indicated in the heartbeat database 127) (e.g., similar to operation 218). When the application orchestration system 101 includes another cluster 103A-D with a higher priority in the ready state, the application processing system 109A-D may perform operation 230. At operation 230, the process monitoring system 109A-D may determine that the cluster 103A-D is to remain in the ready state (since a higher priority cluster is available to perform the application process).

In contrast, when the application orchestration system 101 does not include another cluster 103A-D with a higher priority that is in the ready state, the process monitoring application 109A-D may perform operation 233. At operation 233, the process monitoring application 109A-D may determine whether a lower priority cluster 103A-D (as indicated in the cluster priority list 115) is in the active state (as indicated in the heartbeat database 127). For example, the process monitoring application 109A-D may obtain an identification of the lower priority clusters 103A-D from the cluster priority list 115 and then obtain the state 206A-D of each of these clusters 103A-D from the heartbeat database 127.

When a lower priority cluster 103A-D is not in the active state, the process monitoring application 109A-D may perform operation 239 to update the state 206A-D of the cluster 103A-D to be active. To update the state 206A-D, the process monitoring application 109A-D may send a heartbeat message 270 to the heartbeat system 118, in which the heartbeat message 270 identifies the cluster 103A-D, identifies an address 203A-D of the cluster 103A-D, and indicates that the cluster 103A-D is now in the active state (e.g., no longer in the ready state). The heartbeat system 118 may update the record 205 for the cluster 103A-D to update the state 206A-D to the active state and add a time of receiving the heartbeat message 275 to the record 205.

The process monitoring application 109A-D may also instruct the main processing application 106A-D of the respective cluster 103A-D to begin performing the application process 102, in some cases, using the prior application state data 141. In response to receiving the instruction, the main processing application 106A-D may perform the application process 102, in some cases, using the prior application state data 141.

In contrast, when a lower priority cluster 103A-D is indeed in the active state, the process monitoring application 109A-D may perform operation 236. At operation 236, the process monitoring application 109A-D may determine that the cluster 103A-D is to remain in the ready state (to prevent the application process from being performed by multiple clusters at the same time).

Continuing with the example above, suppose that at the next interval of the predefined schedule, all of the clusters 103A-D associated with the application process 102, including the second cluster 103B, may perform the same method 210. For example, at this stage, the second cluster 103B is still in the ready state, and the application process 102 is no longer being performed by the first cluster 103A. The process monitoring application 109B of the second cluster 103B may perform operation 227 to determine whether the cluster priority list 115 indicates that another cluster 103A-D has a higher priority than the second cluster 103B for performing the application process 102. As shown in FIG. 2, the second cluster 103B is the highest priority cluster 103A-D for the application process 101, and there is no higher priority cluster 103A-D.

Therefore, the process monitoring application 109B of the second cluster 103B may perform operation 223, to determine whether a lower priority cluster 103A, 103C, and 103D, as indicated in the cluster priority list 115, is in the active state, as indicated in the heartbeat database 127. In this case, the cluster 103A is a lower priority cluster identified in the cluster priority list 115, but the state of the cluster 103A is in the ready state (i.e., not in the active state). As such, the process monitoring application 109B of the second cluster 103B may perform operation 239 to update the status 209B of the cluster 103B to indicate that the cluster 103B is in the active state. The process monitoring application 109B may also instruct the main processing application 106B of the second cluster 103B to begin performing the application process 102.

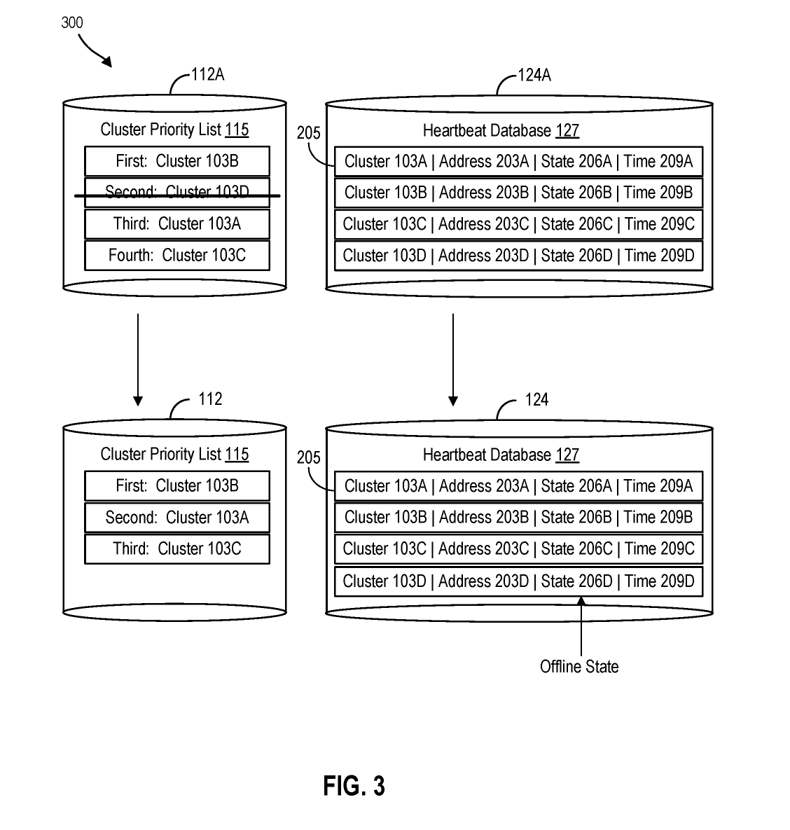

Referring now to FIG. 3, shown is a diagram 300 illustrating the modifications to the cluster priority list 115 and heartbeat database 127 when a cluster 103D becomes unavailable. In various embodiments, the application 121 at the heartbeat system 118 may detect that the cluster 103D is unavailable due to an outage. The application 121 may detect that the cluster 103D has become unavailable and entered an offline state when the application 121 has not received a heartbeat message from the cluster 103D within a threshold period of time. For example, the application 121 may determine that the cluster 103D has become unavailable and entered an offline state when the application 121 has not received a heartbeat message from the cluster 103D within the past one minute. The application 121 may compare a current time with the time 209D indicated in the record 205 for the cluster 103D. Alternatively, the application 121 may receive a message from an operator of the application orchestration system 101 indicating that the cluster 103D is experiencing an outage to determine that the cluster 103D has become unavailable and entered an offline state.

The application 121 may then update the state 206D of the cluster 103D in the record 205 for the cluster 103D, to indicate that the cluster 103D is currently in an offline state. In some cases, the application 121 may also update the time 209D in the record 205 for the cluster 103D to indicate the time of the determination that the cluster 103D has gone offline. In some cases, the application 121 may also add a flag indicating that a heartbeat message was not actually received to make the determination, rather, the application 121 inferred that the cluster 103D has gone offline based on the threshold comparison. FIG. 3 shows the heartbeat database 127 being updated such that the record 205 for the cluster 103D includes the state 206D indicating the offline state.

The application 121 may also transmit an instruction to the data store 112 to update the cluster priority list 115 to remove the cluster 103D from the cluster priority list 115 upon determining that the cluster 103D has gone offline. In an embodiment, updating the cluster priority list 115 may refer to updating another database storing an updated cluster priority list with the same list of ordered clusters as the cluster priority list 115. However, the other database may be updated to remove the cluster 103D for processing purposes. Meanwhile, the original cluster priority list 115 may remain static and unchanged to maintain knowledge of the order of clusters indicated in the cluster priority list 115, in case cluster 103D is restored. By removing the cluster 103D from the cluster priority list 115, the order of priority of the clusters 103A-C changes. While cluster 103B remains the highest priority, cluster 103A becomes the second highest priority, and cluster 103C becomes the lowest priority. FIG. 3 shows the cluster priority list 115 being updated to reflect the removal of the offline cluster 103D (as reflected by the line through the cluster 103D in FIG. 3).

In an embodiment, the process monitoring applications 109A-C across all of the associated clusters 103A-C may account for the updated cluster priority list 115 and offline cluster 103D at the next interval of the predefined schedule (e.g., when the process monitoring applications 109A-C across all of the associated clusters 103A-C run the next set of monitoring and updating tasks of method 210). In another embodiment, the update to the cluster priority list may trigger the process monitoring applications 109A-C across all of the associated clusters 103A-C to run the monitoring and updating tasks of method 210. When the process monitoring applications 109A-C across all of the associated clusters 103A-C run the monitoring and updating tasks of method 210, the remaining clusters 103A-C enforce the updated cluster priority list 115, to ensure that the application process 102 is executed by the next highest priority cluster 103A-C.

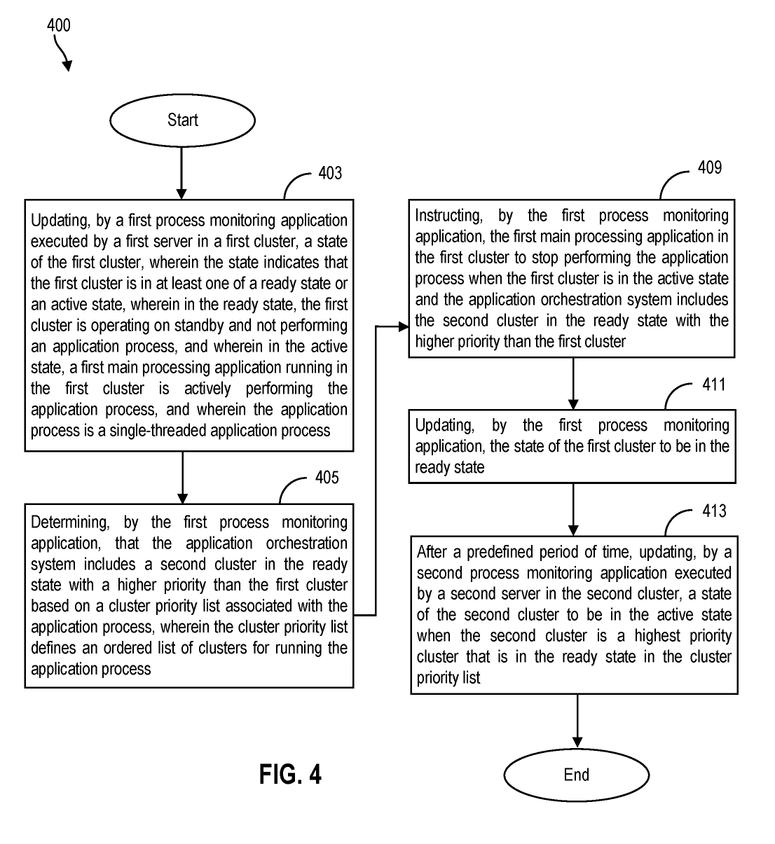

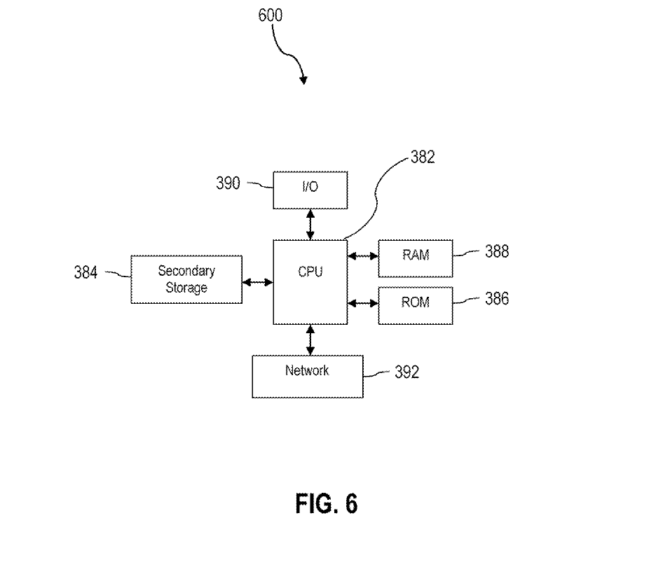

Referring now to FIG. 4, shown is a method 400 for monitoring and controlling processes across clusters 103A-D (sometimes referred to hereinafter as “cluster 103”) according to various embodiments disclosed herein. Method 400 may be implemented by the process monitoring applications 109A-D (sometimes hereinafter referred to as “process monitoring application 109”) and the main processing applications 106A-D (sometimes referred to hereinafter as “main processing application 106”) of each of the clusters 103 in the application orchestration system 101FIG. 1. In embodiments, the method 400 may be implemented using a computer system with components as shown in FIG. 6. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At step 403, method 400 may comprise updating, by a first process monitoring application 109A executed by a first server (e.g., node 105) in a first cluster 103A, a state 206A of the first cluster 103A. The state 206A indicates that the first cluster 103A is in at least one of a ready state or an active state. In the ready state, the first cluster 103A is operating on standby and not performing an application process 102, and in the active state, a first main processing application 106A running in the first cluster 103A is actively performing the application process 102.

At step 405, method 400 may comprise determining, by the first process monitoring application 109A, that the application orchestration system 101 includes a second cluster 103B in the ready state with a higher priority than the first cluster 103A based on a cluster priority list 115 associated with the application process 102. At step 409, method 400 may comprise instructing, by the first process monitoring application 109A, the first main processing application 106A in the first cluster 103A to stop performing the application process 102 when the first cluster 103A is in the active state and the application orchestration system 101 includes the second cluster 103B in the ready state with the higher priority than the first cluster 103A.

At step 411, method 400 may comprise updating, by the first process monitoring application 109A, the state 206A of the first cluster 103A to be in the ready state. At step 413, method 400 may comprise after a predefined period of time, updating, by a second process monitoring application 109B executed by a second server (e.g., node 105) in the second cluster 103B, a state 206B of the second cluster 103B to be in the active state when the second cluster 103B is a highest priority cluster that is in the ready state in the cluster priority list 115.

Method 400 may include other steps and/or features that are not otherwise shown in FIG. 4. In an embodiment, after the predefined period of time, the method further comprises maintaining, by the first process monitoring application 109A, the ready state of the first cluster 103A when the application orchestration system 101 includes the second cluster 103A with the higher priority in the active state. In an embodiment, updating, by the second process monitoring application 109B, the state 206B of the second cluster 103B comprises transmitting, by the second process monitoring application 109B, a heartbeat message to a heartbeat system 118 of the application orchestration system 101, the heartbeat message including an identification of the second cluster 103B, an address 203B of the second cluster 103B, and an indication that the second cluster 103B is in the active state (e.g., the state 206B of the second cluster 103B).

In an embodiment, method 400 may further comprise updating, by an application 121 of the heartbeat system 118, a record 205 corresponding to the second cluster 103B to include the address 203B of the second cluster 103B, the indication that the second cluster 103B is in the active state (e.g., the state 206B of the second cluster 103B), and a timestamp of receiving the heartbeat message. In an embodiment, after a second predefined period of time, method 400 may further comprise maintaining, by the second process monitoring application 109B, the active state of the second cluster 103B when the second cluster 103B is a highest priority cluster in the cluster priority list 115 associated with the application process 102 that is in the ready state or the active state.

In an embodiment, method 400 may further comprise performing, by a second main processing application 106B running in the second cluster 103B, the application process 102 after updating the state of the second cluster 103B to be in the active state. In an embodiment, method 400 may further comprise transmitting, by the second main processing application 106B, a call to the second process monitoring application 109B periodically according to a predefined schedule, determining, by the second process monitoring application 109B, that the call has not been received according to the predefined schedule at least a threshold number of times, updating, by the second process monitoring application 109B, the state 206B of the second cluster to be in the offline state when the call has not been received according to the predefined schedule at least the threshold number of times, and instructing, by the second process monitoring application 109B, the second main processing application 106B in the second cluster 103B to stop performing the application process 102 after updating the state 206B of the second cluster 103B to be in the offline state.

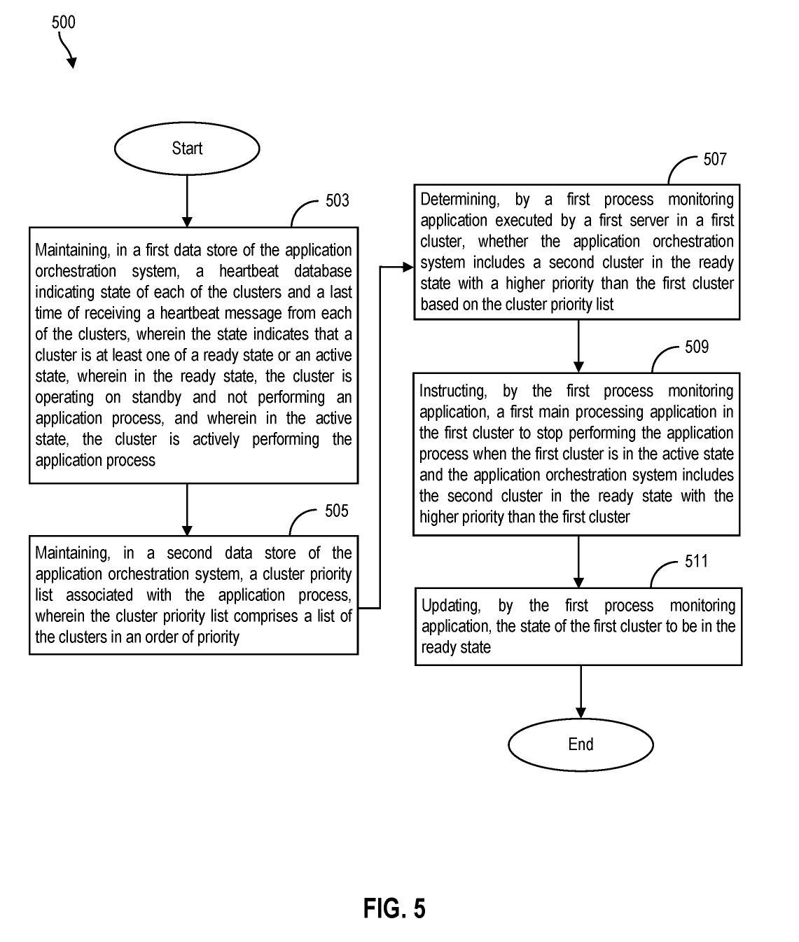

Referring now to FIG. 5, shown is a method 500 for monitoring and controlling processes across clusters 103A-D according to various embodiments disclosed herein. Method 500 may be implemented by the process monitoring applications 109A-D and the main processing applications 106A-D of each of the clusters 103 in the application orchestration system 101FIG. 1. In embodiments, the method 500 may be implemented using a computer system with components as shown in FIG. 6. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 may comprise maintaining, in a first data store 124 of the application orchestration system 101, a heartbeat database 127 indicating state 206A-D (sometimes referred to hereinafter as a “state 206”) of each of the clusters 103 and a last time of receiving a heartbeat message from each of the clusters 103. The state 206 indicates that a cluster 103 is at least one of a ready state or an active state. In the ready state, the cluster 103 is operating on standby and not performing an application process 102, and in the active state, the cluster 103 is actively performing the application process 102.

At step 505, method 500 may comprise maintaining, in a second data store 112 of the application orchestration system 101, a cluster priority list 115 associated with the application process 102. The cluster priority list 115 comprises a list of the clusters 103 in an order of priority.

At step 507, method 500 may comprise determining, by a first process monitoring application 109A executed by a first server (e.g. node 105) in a first cluster 103A, whether the application orchestration system 101 includes a second cluster 103B in the ready state with a higher priority than the first cluster 103A based on the cluster priority list 115. At step 509, method 500 may comprise instructing, by the first process monitoring application 109A, a first main processing application 106A in the first cluster 103A to stop performing the application process 102 when the first cluster 103A is in the active state and the application orchestration system 101 includes the second cluster 103B in the ready state with the higher priority than the first cluster 103B. At step 511, method 500 may comprise updating, by the first process monitoring application 109A, the state 206A of the first cluster 103A to be in the ready state.

Method 500 may include other steps and/or features that are not otherwise shown in FIG. 5. In an embodiment, after a predefined period of time, updating, by a second process monitoring application 109B executed by a second server (e.g., node 105) in the second cluster (103B), a state 206B of the second cluster 103B to be in the active state when the second cluster 103B is a highest priority cluster that is in the ready state in the cluster priority list 115 and when application process 102 is not being actively performed by the first cluster 103A. In an embodiment, method 500 may further comprise performing, by a second main processing application 106B running in the second cluster, the application process 102 after updating the state 206B of the second cluster 103B to be in the active state. In an embodiment, after the predefined period of time, method 500 may further comprise maintaining, by the first process monitoring application 109A, the ready state of the first cluster 103A when the application orchestration system 101 includes the second cluster 103B with the higher priority in the active state.

In an embodiment, updating, by the first process monitoring application 109A, the state 206A of the second cluster 103B comprises transmitting, by the first process monitoring application 109A, a heartbeat message to the heartbeat database 127, the heartbeat message including an identification of the first cluster 103A, an address 203A of the first cluster 103A, and an indication that the first cluster 103A is in the ready state (e.g., the state 206A of the first cluster 103A). In an embodiment, method 500 may further comprise updating, by an application 121 of the heartbeat system 118, a record 205 corresponding to the first cluster 103A to include the address 203A of the first cluster 103A, indication that the first cluster 103A is in the ready state (e.g., the state 206A of the first cluster 103A), and a timestamp of receiving the heartbeat message.

In an embodiment, method 500 may further comprise receiving, by the second main processing application 106B, prior application state data 141 associated with the application process 102 from a data store 140 after the first main processing application 106A has stopped performing the application process 102. The prior application state data 141 is used to perform, by the second main processing application 106B, the application process 102.

FIG. 6 illustrates a computer system 600 suitable for implementing one or more embodiments disclosed herein. In an embodiment, the cluster 103, node, 105, application 121, main processing application 106, and/or the process monitoring application 109., may each be implemented as the computer system 600. The computer system 600 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 600, at least one of the CPU 382, the RAM 388, and the ROM 386 are changed, transforming the computer system 600 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 600 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 384, to the ROM 386, to the RAM 388, and/or to other non-volatile memory and volatile memory of the computer system 600. The processor 382 may process the executable instructions and/or data structures in part by directly accessing the computer program product, for example by reading from a CD-ROM disk inserted into a disk drive peripheral of the computer system 600. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 600.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 600 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in an application orchestration system to monitor and control processes across a plurality of clusters in the application orchestration system, wherein the method comprises:
updating, by a first process monitoring application executed by a first server in a first cluster, a state of the first cluster, wherein the state indicates that the first cluster is in at least one of a ready state or an active state, wherein in the ready state, the first cluster is operating on standby and not performing an application process, wherein in the active state, a first main processing application running in the first cluster is actively performing the application process, and wherein the application process is a single-threaded application process;
determining, by the first process monitoring application, that the application orchestration system includes a second cluster in the ready state with a higher priority than the first cluster based on a cluster priority list associated with the application process, wherein the cluster priority list defines an ordered list of clusters for running the application process;
instructing, by the first process monitoring application, the first main processing application in the first cluster to stop performing the application process when the first cluster is in the active state and the application orchestration system includes the second cluster in the ready state with the higher priority than the first cluster;
updating, by the first process monitoring application, the state of the first cluster to be in the ready state; and
after a predefined period of time, updating, by a second process monitoring application executed by a second server in the second cluster, a state of the second cluster to be in the active state when the second cluster is a highest priority cluster that is in the ready state in the cluster priority list.

2. The method of claim 1, wherein after the predefined period of time, the method further comprises maintaining, by the first process monitoring application, the ready state of the first cluster when the application orchestration system includes the second cluster with the higher priority in the active state.

3. The method of claim 1, wherein updating, by the second process monitoring application, the state of the second cluster comprises transmitting, by the second process monitoring application, a heartbeat message to a heartbeat system of the application orchestration system, the heartbeat message including an identification of the second cluster, an address of the second cluster, and an indication that the second cluster is in the active state.

4. The method of claim 3, further comprising updating, by an application of the heartbeat system, a record corresponding to the second cluster to include the address of the second cluster, the indication that the second cluster is in the active state, and a timestamp of receiving the heartbeat message.

5. The method of claim 1, wherein after a second predefined period of time, the method further comprises maintaining, by the second process monitoring application, the active state of the second cluster when the second cluster is a highest priority cluster in the cluster priority list associated with the application process that is in the ready state or the active state.

6. The method of claim 1, wherein the application process is a large-scale event detector, and wherein the method further comprises performing, by a second main processing application running in the second cluster, the application process after updating the state of the second cluster to be in the active state.

7. The method of claim 6, further comprising:
transmitting, by the second main processing application, a call to the second process monitoring application periodically according to a predefined schedule;
determining, by the second process monitoring application, that the call has not been received according to the predefined schedule at least a threshold number of times;
updating, by the second process monitoring application, the state of the second cluster to be in an offline state when the call has not been received according to the predefined schedule at least the threshold number of times; and
instructing, by the second process monitoring application, the second main processing application in the second cluster to stop performing the application process after updating the state of the second cluster to be in the offline state.

8. A method implemented in an application orchestration system to monitor and control processes across a plurality of clusters in the application orchestration system, wherein the method comprises:
maintaining, in a first data store of the application orchestration system, a heartbeat database indicating state of each of the clusters and a last time of receiving a heartbeat message from each of the clusters, wherein the state indicates that a cluster is at least one of a ready state or an active state, wherein in the ready state, the cluster is operating on standby and not performing an application process, and wherein in the active state, the cluster is actively performing the application process;
maintaining, in a second data store of the application orchestration system, a cluster priority list associated with the application process, wherein the cluster priority list comprises a list of the clusters in an order of priority;
determining, by a first process monitoring application executed by a first server in a first cluster, whether the application orchestration system includes a second cluster in the ready state with a higher priority than the first cluster based on the cluster priority list;
instructing, by the first process monitoring application, a first main processing application in the first cluster to stop performing the application process when the first cluster is in the active state and the application orchestration system includes the second cluster in the ready state with the higher priority than the first cluster; and
updating, by the first process monitoring application, the state of the first cluster to be in the ready state.

9. The method of claim 8, wherein after a predefined period of time, updating, by a second process monitoring application executed by a second server in the second cluster, a state of the second cluster to be in the active state when the second cluster is a highest priority cluster that is in the ready state in the cluster priority list and when the application process is not being actively performed by the first cluster.

10. The method of claim 9, further comprising performing, by a second main processing application running in the second cluster, the application process after updating the state of the second cluster to be in the active state.

11. The method of claim 10, further comprising receiving, by the second main processing application, prior application state data associated with the application process from a data store after the first main processing application has stopped performing the application process, wherein the prior application state data is used to perform, by the second main processing application, the application process.

12. The method of claim 11, further comprising updating, by an application, a record corresponding to the first cluster to include an address of the first cluster, the indication that the first cluster is in the ready state, and a timestamp of receiving the heartbeat message.

13. The method of claim 8, wherein after a predefined period of time, the method further comprises maintaining, by the first process monitoring application, the ready state of the first cluster when the application orchestration system includes the second cluster with the higher priority in the active state.

14. The method of claim 8, wherein updating, by the first process monitoring application, the state of the first cluster comprises transmitting, by the first process monitoring application, the heartbeat message to the heartbeat database, the heartbeat message including an identification of the first cluster, an address of the first cluster, and an indication that the first cluster is in the ready state.

15. An application orchestration system, comprising:
a memory comprising:
a first data store configured to store a heartbeat database indicating a state of a plurality of clusters and a last time of receiving a heartbeat message from each of the clusters, wherein the state of a cluster indicates that the cluster is in at least one of a ready state or an active state, wherein in the ready state, the cluster is operating on standby and not performing an application process, and wherein in the active state, the cluster is actively performing the application process; and
a second data store configured to store a cluster priority list associated with the application process, wherein the cluster priority list comprises a list of the clusters in an order of priority;
the plurality of clusters associated with the application process, wherein each cluster comprises:
a process monitoring application comprising instructions, which when executed by a processor of the cluster, causes the process monitoring application to be configured to:
when the cluster is in the ready state:
remain in the ready state when a higher priority cluster is in the active state, wherein the higher priority cluster is indicated in the cluster priority list; or
update to the active state when the cluster is a highest priority cluster as indicated in the cluster priority list; and
when the cluster is in the active state:
remain in the active state when the cluster is a highest priority cluster as indicated in the cluster priority list; or
update to the ready state when the higher priority cluster is in the ready state, wherein the higher priority cluster is indicated in the cluster priority list.

16. The application orchestration system of claim 15, wherein the process monitoring application is further configured to update the state of the cluster in the first data store when the cluster is updated to the active state or the ready state.

17. The application orchestration system of claim 16, wherein to update the state of the cluster in the first data store, the process monitoring application is further configured to transmit a heartbeat message to the first data store, wherein the heartbeat message indicates the state of the cluster and an address of the cluster.

18. The application orchestration system of claim 15, wherein the cluster priority list includes one or more of the clusters.

19. The application orchestration system of claim 15, wherein one or more of the clusters may be offline, and wherein when the cluster is offline, the cluster is not in a ready state or an active state.

20. The application orchestration system of claim 15, wherein each cluster further comprises a main processing application configured to perform the application process when the cluster is in the active state.
